(19) United States
(12) Patent Application Publication
(10) Pub. No.: US 2021/0067620 A1
(43) Pub. Date: Mar. 4, 2021

(54) SHAPEABLE TABLET AND CELL PHONE HOLDING DEVICE

(71) Applicants: Scott Anderson, Bethesda, MD (US); Christopher Hegglund, Bethesda, MD (US)

(72) Inventors: Scott Anderson, Bethesda, MD (US); Christopher Hegglund, Bethesda, MD (US)

(21) Appl. No.: 16/812,285

(22) Filed: Mar. 7, 2020

Related U.S. Application Data
(60) Provisional application No. 62/866,153, filed on Aug. 27, 2019.

(51) Int. Cl. H04M 1/04; G06F 1/16

(52) U.S. Cl. CPC H04M 1/04; G06F 1/1632

(57) ABSTRACT

A shapeable tablet and cell phone holding device is disclosed herein. The purpose of the shapeable tablet and cell phone holding device is to support any object or device, especially a smart phone or tablet, against a surface or another object. The device functions by being infinitely formable, allowing a user to conform the shapeable tablet and cell phone holding device to the held object and the supporting surface. The composition of the device is such that it will rigidly maintain the shape given to it while holding the object, though can also be returned to a flat or folded orientation for storage or carrying. The device can support smart devices of any thickness and size, and can be folded and held at any orientation and angle to maximize versatility. The outer cover may be made of high-quality silicone and have an inner metallic core that allows securely positioning of a smart device as required by a user.

### TECHNICAL FIELD OF THE INVENTION

The present invention relates in general to mobile device accessories, and, more specifically, to a shapeable tablet and cell phone holding device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

In recent years, most electronic devices, such as mobile phones, tablet computers, and e-readers have been made in various sizes and shapes for the consumer public. Examples of such devices include the Ipad, Nook, Kindle, and others. Due to the popularity of such devises, which are readily available to consumers, a number of accessories have been created to position, hold, secure, and protect them.

Most smart phones and tablets comprise a one-piece body having an integrated flat screen. Inputs to the device are generally made via a virtual keyboard appearing on the screen, or via a physical keyboard wirelessly connected to the device. Some smart phones and tablets may also use an input pen for input. As the increasing pace of life and requirements of these smart devices are increasing day by day, the need for them to be placed at a proper viewing position is also very much required, whether the user is reading an e-book at home, or needs to read while travelling in car, sitting in a hotel room, or in any other place.

There are multiple solutions for holding such smart phones and tablets that have been presented in the prior art. For instance, a means for mounting a tablet disclosed in Canadian patent 102,869,542 is issued to a Chinese inventor. The patent relates to a tablet holder, particularly for a vehicle seat component such as a seat base, a backrest, a headrest, or the headrest holder. The device comprises the holding device, a means for mounting on the vehicle seat component; and supporting elements movably connected to the holder for accommodating the tablet.

A second patent discloses a magnetic stand for a tablet device in U.S. patent application Ser. No. 13/223,110. The magnetic stand is configured to rigidly hold a portion of the tablet device in place and to shield the magnetic field to prevent adversely affecting nearby devices susceptible to strong magnetic fields. The shielding portion of the magnetic stand allows for significant increases in magnetic field strength of the held device when compared to similarly configured, unshielded products.

Another device for tablet and monitor support systems is disclosed in Canadian patent 103,988,143. The support system comprises a bracket configured to support a monitor called a monitor support portion, and a bracket configured to support a tablet called a tablet support portion.

Another tablet holder is disclosed in U.S. Pat. No. 8,424,830. The patent discloses a holder for holding a portable electronic device that can be changed between a folded position and an unfolded position. The holder holds the portable electronic device in the folded position. In the unfolded position, the holder has its supporting board, front holding board, rear holding board, side holding boards, and bottom holding boards substantially planar with each other. In the folded position, the supporting board orients the side holding boards into a vertical stand with the rear holding board secured above the supporting board at an obtuse angle, and the front holding board is maintained parallel with the rear holding board.

Another tablet stand is disclosed in U.S. Pat. No. 5,607,135. The patent discloses a foldable one-piece tablet stand comprising a base section, a back rest section that can be raised and lowered into the base section, and a pair of protrusions that can be raised and lowered into the base and disposed at a front part of the base section so that when both the back rest section and protrusions are in the raised conditions. A tablet is held by the back rest section with a bottom of the tablet held by the base section and secured by the pair of protrusions and a holder section that is foldable into the base section. A hinge on the back of the back rest section allows the back rest section to be fixed thereby, whereby an inexpensive one piece plastic construction is possible to form the tablet stand with efficiency and economy.

Another tablet computer holder and stand bearing is disclosed in a U.S. Pat. No. 8,941,989. The patent discloses a handle assembly for a hand-held tablet computer or other handheld electronic device. The assembly includes a tablet mounted assembly adhered to the back side of the tablet computer opposite the tablet's screen and a handle removably mounted to the tablet mounted assembly. The handle is rotatable, permitting a user to hold the tablet computer within one hand and rotate the tablet computer to access the screen from any desired angle. The handle may include at least one tab and the tablet mounted portion includes at least one opening sized to receive the tab. The mounting plate may include a release tab to releasably engage a recess in the base plate of the handle and secure the tab of the handle within the opening of the mounting plate.

Another tablet computer holder and support is disclosed in U.S. Pat. No. 8,235,334. The patent discloses a foldable support for a tablet computer or other object as an upright, self-standing, or anchorable device. A base having foldout wings is adapted to be rotated in place and anchored under the legs of a person in a seated position, or under the person's torso in a reclining or supine person. The support includes a body with a recessed portion into which the base is attached about a horizontal axle to enable the rotation. Two arms are rotatably pinned together with the other ends attached to ball joints on the body and a receptacle. The receptacle holds the tablet computer or other object and includes a frame housing with rotatably attached rods that extend outwardly from side openings in the frame. A gripper is mounted to the far end of each rod to hold the corners or edges of the tablet computer or other object mounted between the grippers.

There are multiple inventions that have been proposed in prior art regarding tablet holder and mounting system. However, the utility of these systems has not been seen in advance form and for specialized needs. The other similar products in the market provide hinges that are not friction torque hinges. Moreover, the present assemblies require space for a stand base or mounting clamps. The material and utility of movement of the holders is also restricted and does not allow a free 360 degree movement.

The current invention proposes a system that provides a universal design that means it can accommodate every cell phone and tablet. The assembly is suitable for all settings regardless of users' location or needs. The assembly can be placed at a comfortable position while travelling within airplanes or any road vehicles. The system is also suitable for use in the kitchen, gym, pool, spa, office, or any other space where the user can be. The proposed assembly is totally hands-free and is highly portable allowing it to be carried easily.

Thus, there is a need in the art for a shapeable tablet and cell phone holding device that comprises a small, flexible form factor that can mount on any surface while remaining hands-free and portable. It is to these ends that the present invention has been developed.

### BRIEF SUMMARY OF THE INVENTION

To minimize the limitations in the prior art, and to minimize other limitations that will be apparent upon reading and understanding the present specification, the present invention describes a shapeable tablet and cell phone holding device.

It is an objective of the present invention to provide a shapeable tablet and cell phone holding device that may comprise a mobile device holder.

It is another objective of the present invention to provide a shapeable tablet and cell phone holding device that may comprise a resilient main body.

It is another objective of the present invention to provide a shapeable tablet and cell phone holding device that may comprise a resilient internal structure.

It is another objective of the present invention to provide a shapeable tablet and cell phone holding device that may comprise a single-component construction.

It is another objective of the present invention to provide a shapeable tablet and cell phone holding device that may comprise a multiple-component construction.

It is another objective of the present invention to provide a shapeable tablet and cell phone holding device that may comprise a resilient material of construction.

It is another objective of the present invention to provide a shapeable tablet and cell phone holding device that may comprise a cleanable material of construction.

It is another objective of the present invention to provide a shapeable tablet and cell phone holding device that may comprise a reusable material of construction.

It is another objective of the present invention to provide a shapeable tablet and cell phone holding device that may comprise an antimicrobial layer.

It is another objective of the present invention to provide a shapeable tablet and cell phone holding device that may comprise an antimicrobial material of construction.

It is another objective of the present invention to provide a shapeable tablet and cell phone holding device that may hold a tablet computer or other object in close proximity to a seated person.

It is another objective of the present invention to provide a shapeable tablet and cell phone holding device that may be self-standing and anchorable in place close to a user so that it is remains closely aligned as per user's requirement.

It is another objective of the present invention to provide a shapeable tablet and cell phone holding device that may comprise a small form factor.

It is another objective of the present invention to provide a shapeable tablet and cell phone holding device that may comprise magnetic features to provide quick and easy mount and dismount of a smart device.

It is another objective of the present invention to provide a shapeable tablet and cell phone holding device that may comprise a tight and enclosed assembly that prevents falling down and requiring manual tightening with screws.

It is another objective of the present invention to provide a shapeable tablet and cell phone holding device that may comprise a freely adjustable viewing angle regardless of available mounting points.

It is another objective of the present invention to provide a shapeable tablet and cell phone holding device that may comprise a silicone outer surface.

It is another objective of the present invention to provide a shapeable tablet and cell phone holding device that may comprise a quick, hands-free method for placing and removing a smart device onto the holder.

It is another objective of the present invention to provide a shapeable tablet and cell phone holding device that may comprise a waterproof material of construction.

It is another objective of the present invention to provide a shapeable tablet and cell phone holding device that may comprise a non-complex method of construction.

It is another objective of the present invention to provide a shapeable tablet and cell phone holding device that may comprise a low-cost method of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an upper isometric perspective view of a shapeable tablet and cell phone holding device, as contemplated by the present disclosure;

FIG. 2 illustrates a lower isometric perspective view of a shapeable tablet and cell phone holding device, as contemplated by the present disclosure;

FIG. 3 illustrates a partially dissected upper isometric perspective view of a shapeable tablet and cell phone holding device showing an internal form-holding layer, as contemplated by the present disclosure;

FIG. 4 illustrates a partially dissected upper isometric perspective view of a shapeable tablet and cell phone holding device showing an internal form-holding layer, as contemplated by the present disclosure;

FIG. 5 illustrates a longitudinally hemisected upper isometric perspective view of a shapeable tablet and cell phone holding device showing an internal form-holding layer, as contemplated by the present disclosure;

FIG. 6 illustrates a first exemplary form of a shapeable tablet and cell phone holding device, as contemplated by the present disclosure;

FIG. 7 illustrates a second exemplary form of a shapeable tablet and cell phone holding device, as contemplated by the present disclosure;

FIG. 8 illustrates a third exemplary form of a shapeable tablet and cell phone holding device, as contemplated by the present disclosure; and

FIG. 9 illustrates a third exemplary form of a shapeable tablet and cell phone holding device supporting a smart device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The current invention in a first emboli n discloses a shapeable tablet and cell phone holding device that can be affixed to any solid objects such as a countertop, seats, desk, or other items. The device holds and places any smart devices ranging from any thickness and size in a secured and safe position. The assembly includes a non-slip silicone outer cover that holds the device firmly. The device can be folded and held at any orientation and angle to maximize versatility, adding convenience for the user. The outer cover may be made of high-quality silicone and have an inner metallic core that allows securely held 360-degree positioning of a smart device as required by a user.

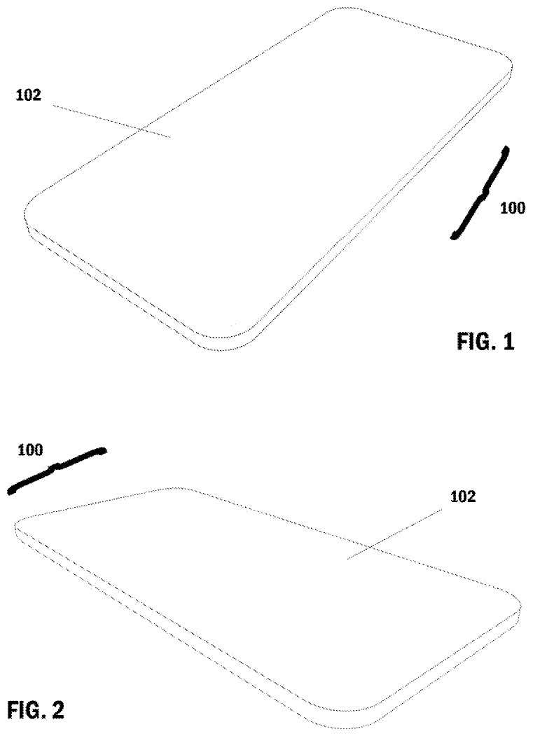

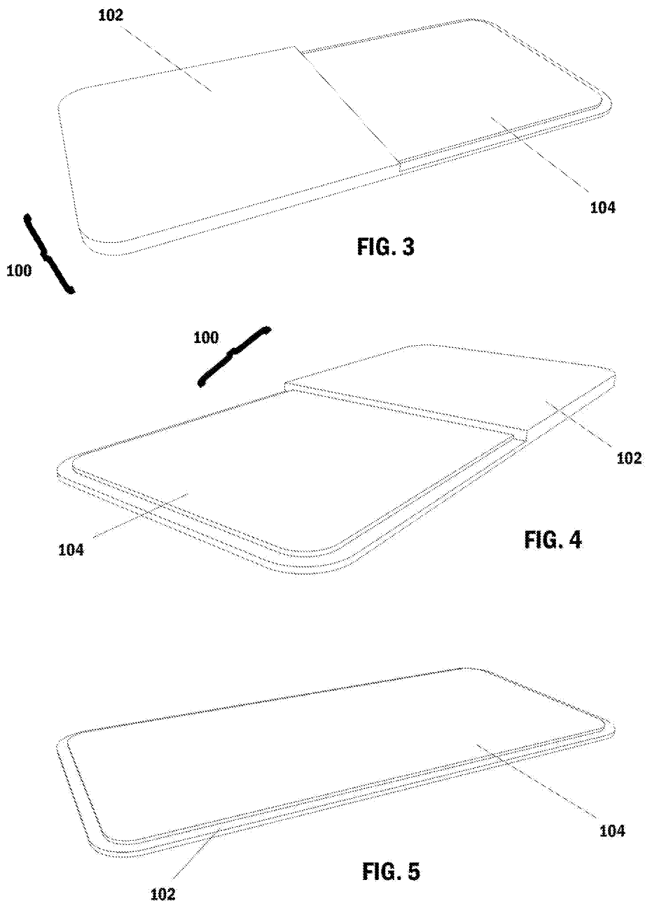

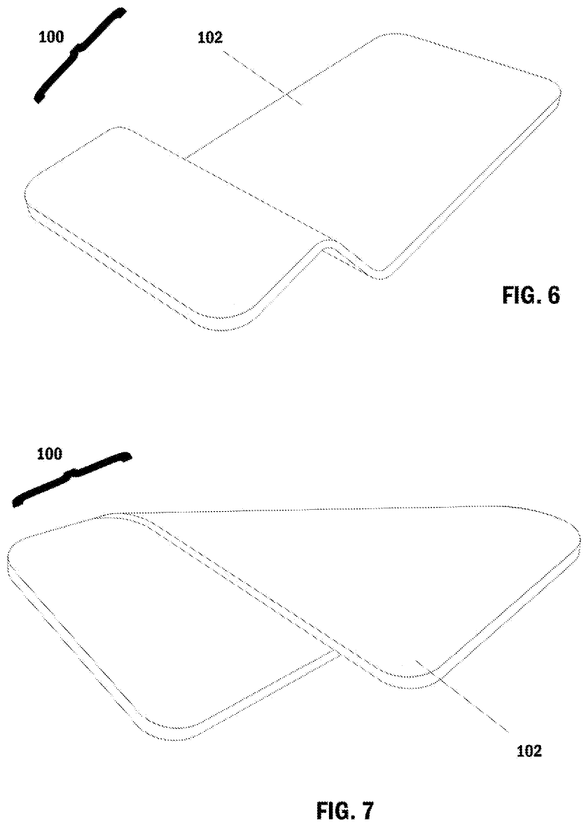

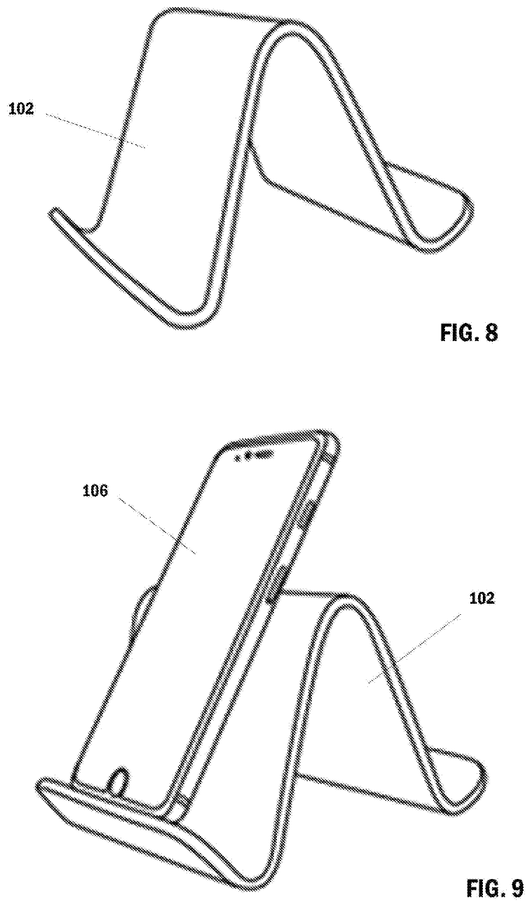

The illustrations of FIGS. 1-9 illustrate a shapeable tablet and cell phone holding device, as contemplated by the present disclosure. The purpose of the shapeable tablet and cell phone holding device is to support any object or device, especially a smart phone 106 or tablet, against a surface or another object. The device functions by being infinitely formable, allowing a user to conform the shapeable tablet and cell phone holding device to the held object and the supporting surface. The composition of the device is such that it will rigidly maintain the shape given to it while holding the object, though can also be returned to a flat or folded orientation for storage or carrying.

The illustrations of FIGS. 1-9 illustrate a shapeable tablet and cell phone holding device, as contemplated by the present disclosure. The device may comprise, generally, a main body 100 having an outer cover 102 and a formable insert 104. The outer cover 102 may comprise any appropriate shape and thickness, though is generally a rectangular shape having rounded corners. The formable insert 104 may comprise any appropriate shape and thickness, though is generally substantially identical to the outer cover 102 in shape and scaled down such that it fits within the outer cover 102. The outer cover 102 may be adhered to the formable insert 104 by any appropriate means such as, for example, by friction fitting, gluing, welding, or stitching.

In an embodiment wherein the main body 100 comprises a multiple-component construction the outer cover 102 may comprise two identical sheets of material and formable insert 104 may comprise a single sheet of material sandwiched therein. In an alternative embodiment the two identical sheets of material of the outer cover 102 may comprise a central depression and a perimeter, and the two sheets may be attached to each other around their perimeter while the formable insert 104 is placed within the central depression of each.

In an embodiment wherein the main body 100 comprises a single-component construction the outer cover 102 may be formed around the formable insert 104 by pressure molding, pour molding, or other appropriate method. In an alternative embodiment the outer cover 102 may comprise a slit or opening at one end that permits installation and removal of the formable insert 104. In this way the outer cover 102 or the formable insert 104 may be replaceable or repairable, if desired.

The outer cover 102 of the main body 100 may comprise any material of construction having flexible and resilient properties. In one embodiment the material of construction of the outer cover 102 may comprise a washable or cleanable material. In another embodiment the material of construction of the outer cover 102 may comprise a non-stick material. In another embodiment the material of construction of the outer cover 102 may comprise a non-slip material.

The formable insert 104 of the main body 100 may comprise any material of construction have formable and resilient properties. In one embodiment the material of construction of the formable insert 104 may comprise a thin, solid sheet of pliable metallic materials. In another embodiment the material of construction of the formable insert 104 may comprise a plurality of thin, solid sheets of rigid materials interlocked and articulating relative to one another. In another embodiment the material of construction of the formable insert 104 may comprise a chain mail assembly of rigid materials.

The main body 100 of the shapeable tablet and cell phone holding device may further comprise additional components and accessories as appropriate. In one embodiment the main body 100 may further comprise a plurality of magnetics for holding an object to the device. In another embodiment the main body 100 may further comprise an electrical connectivity and a storage battery for plugging in and recharging a smart device. In another embodiment the main body 100 may further comprise a wireless fidelity connection to provide a mobile internet hotspot for wireless data transmission. In another embodiment the main body 100 may further comprise a radio connection, such as a Bluetooth connection, to provide wireless nearfield connectivity.

In some embodiments the shapeable tablet and cell phone holding device disclosed herein may be substantially constructed of any suitable material or combination of materials, but typically is constructed of a resilient material or combination of materials such that the combination is resistant to tearing and damage as a result of compression, flexion, or submersion in water. As an example, and without limiting the scope of the present invention, various exemplary embodiments of the outer cover 102 be substantially constructed of one or more materials of silicone, fabric, latex, rubber, plastic, polyurethane, animal skin, or combinations thereof. Various exemplary embodiments of the formable insert 104 be substantially constructed of one or more materials of aluminum, steel, copper, magnesium, or combinations thereof.

In some embodiments the shapeable tablet and cell phone holding device may further comprise a material of construction that either comprises a material having magnetic properties or comprises a layering or a plurality of components of magnetic material or coating. Magnetic properties comprise the characteristic of creating a magnetic field and exerting a magnetic moment. Various exemplary embodiments of magnetic materials may comprise one or more materials of iron, cobalt, nickel, or combinations thereof.

In some embodiments the shapeable tablet and cell phone holding device may further comprise a material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A shapeable tablet and cell phone holding device, comprising:
an outer cover; and
a formable insert;
wherein said formable insert is installed within said outer cover.

2. The invention of claim 1,
wherein said formable insert comprises a material of construction appropriate for retaining an orientation said formable insert is formed into by a user.

3. The invention of claim 2,
wherein said outer cover comprises a single-component construction into which said formable insert is installed.

4. The invention of claim 2,
wherein said outer cover comprises a multiple-component construction into which said formable insert is installed.

5. The invention of claim 2, further comprising:
a resilient material of construction.

6. The invention of claim 2, further comprising:
a cleanable material of construction.

7. The invention of claim 2, further comprising:
a reusable material of construction.

8. The invention of claim 2, further comprising:
an antimicrobial layer.

9. The invention of claim 2, further comprising:
an antimicrobial material of construction.

10. The invention of claim 2, further comprising:
a plurality of magnets;
wherein said plurality of magnets are installed within said outer cover.
an electrical connectivity;
wherein said electrical connectivity is installed within said outer cover.

11. The invention of claim 2, further comprising:
a storage battery;
wherein said storage battery is installed within said outer cover.

12. The invention of claim 2, further comprising:
a mobile internet hotspot;
wherein said mobile internet hotspot is installed within said outer cover.

13. The invention of claim 2, further comprising:
a near-field communication connection
wherein said near field communication is installed within said outer cover.
